(19) United States
(12) Patent Application Publication
(10) Pub. No.: US 2008/0132189 A1
(43) Pub. Date: Jun. 5, 2008

(54) MIXING DAC AND POLYPHASE FILTER ARCHITECTURES FOR A RADIO FREQUENCY RECEIVER

(75) Inventors: Adrian Maxim, Austin, TX (US); Matthew Powell, Cedar Park, TX (US); Scott T. Dupuie, Lakeway, TX (US); Richard A. Johnson, Buda, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: SILICON LABORATORIES, INC., Austin, TX (US)

(21) Appl. No.: 11/565,481

(22) Filed: Nov. 30, 2006

(51) Int. Cl. H04B 1/18

(52) U.S. Cl. 455/280

(57) ABSTRACT

A receiver (200) includes a mixing digital-to-analog converter (DAC) (208), a direct digital frequency synthesizer (DDFS), a transimpedance amplifier (TIA) (204) and a first polyphase filter (PPF) (202). The mixing DAC (208) includes a radio frequency (RF) transconductance section for providing an RF current signal responsive to an RF signal and a switching section. The switching section is coupled to the RF transconductance section and includes inputs for receiving bits associated with a digital local oscillator (LO) signal. The switching section is configured to mix the RF current signal with the digital LO signal to provide an analog output signal at outputs of the switching section. The transimpedance amplifier (TIA) (204) includes inputs each coupled to a respective one of the outputs of the switching section and outputs. The first PPF (202) includes inputs each coupled to a respective one the outputs of the TIA (204).

### TECHNICAL FIELD

The present invention is generally directed to a radio frequency (RF) receiver and, more particularly, to mixing digital-to-analog converter and polyphase filter architectures for an RF receiver.

### BACKGROUND

In communication systems having weak desired signals accompanied by broadband strong blocker signals that fall into an image channel of a desired channel, radio frequency (RF) receivers with high image rejection are desirable. One approach to achieve high image rejection for an RF receiver has implemented two quadrature mixer stages within the receiver (known as a Weaver receiver). Unfortunately, Weaver receivers tend to be relatively complex, due to the implementation of two quadrature mixers and two frequency synthesizers, and also tend to have relatively large power requirements. An alternative solution has implemented a single quadrature mixer and a passive ninety-degree phase shifter that caused desired channel components to add in-phase, while image channel components added out-of-phase to provide first-order image cancellation. In at least one prior art receiver, the ninety-degree phase shifter has been provided by a polyphase filter (PPF), e.g., a passive PPF.

In general, a passive PPF does not draw power and phase shifting accuracy of the passive PPF is determined by matching on-chip resistors and capacitors. To achieve a relatively large image rejection, a PPF may implement a number of cascaded stages. To avoid undesirable signal attenuation, resistor values of a PPF have been scaled-up from an input of the PPF to an output of the PPF. In high-order PPFs, resistors in the last stages of the PPF may contribute a relatively large amount of noise. In a typical receiver that implements a quadrature mixer in combination with one or more PPFs, the image rejection of the receiver is generally limited by phase matching of in-phase (I) and quadrature (Q) local oscillator (LO) signals. In the case of an analog implementation using a phase locked loop (PLL) frequency synthesizer, a native image rejection of a receiver is normally limited to about 30 to 40 decibels (dBs) which is usually not adequate for modern hybrid analog/digital terrestrial TV or cable TV.

What is needed are techniques that increase an image rejection capability of a radio frequency receiver.

### SUMMARY

According to one embodiment of the present invention, a receiver includes a mixing digital-to-analog converter (DAC), a direct digital frequency synthesizer (DDFS), a transimpedance amplifier (TIA) and a first polyphase filter (PPF). The mixing DAC includes a radio frequency (RF) transconductance section and a switching section. The RF transconductance section includes an input for receiving an RE signal and an output for providing an RF current signal. The switching section is coupled to the RF transconductance section and includes inputs for receiving bits associated with a digital local oscillator (LO) signal. The switching section is configured to mix the RF current signal with the LO signal to provide an analog output signal at outputs of the switching section. The DDFS includes outputs configured for providing the bits associated with the LO signal to the inputs of the switching section. The transimpedance amplifier (TIA) includes inputs each coupled to a respective one of the outputs of the switching section and outputs. The first PPF includes inputs each coupled to a respective one the outputs of the TIA.

According to another aspect of the present invention, a receiver includes a mixing digital-to-analog converter (DAC), a direct digital frequency synthesizer (DDFS), a first polyphase filter (PPF), a second PPF and a plurality of buffers. The mixing DAC includes a radio frequency (RF) transconductance section, a switching section and a pair of resistive loads. The RF transconductance section includes an input for receiving an RF signal and an output for providing an RF current signal. The switching section is coupled to the RF transconductance section and includes inputs for receiving bits associated with a digital local oscillator (LO) signal. The switching section is configured to mix the RF current signal with the LO signal to provide an analog output signal at outputs of the switching section. The resistive loads are each coupled to respective ones of the outputs of the switching section. The DDFS includes outputs configured for providing the bits associated with the LO signal to the inputs of the switching section. The first PPF includes inputs coupled to respective ones of the outputs of the switching section. The second PPF includes a plurality of inputs and a plurality of outputs. The plurality of buffers each couple a respective one of the outputs of the first PPF to a respective one of the inputs of the second PPF.

According to another embodiment of the present invention, a receiver includes a mixing digital-to-analog converter (DAC), a direct digital frequency synthesizer (DDFS), a passive polyphase filter (PPF), a differential amplifier and a bandpass filter. The mixing DAC includes a radio frequency (RF) transconductance section, a switching section and a pair of resistive loads. The RF transconductance section includes an input for receiving an RF signal and an output for providing an RF current signal. The switching section is coupled to the RF transconductance section and includes inputs for receiving bits associated with a digital local oscillator (LO) signal. The switching section is configured to mix the RF current signal with the LO signal to provide an analog output signal at outputs of the switching section. The resistive loads are each coupled to respective ones of the outputs of the switching section. The DDFS includes outputs configured for providing the bits associated with the LO signal to the inputs of the switching section. The passive PPF includes inputs each coupled to respective ones of the outputs of the switching section. The differential amplifier includes inputs each coupled to respective outputs of the PPF. The bandpass filter includes inputs each coupled to respective outputs of the differential amplifier.

### BRIEF DESCRIPTION OF THE DRAWINGS

The present disclosure may be better understood, and its numerous features and advantages made apparent to those skilled in the art by referencing the accompanying drawings.

FIG. 1 is an electrical diagram, in block and schematic form, of a relevant portion of an exemplary radio frequency (RF) receiver that implements a mixing digital-to-analog converter (DAC), according to an embodiment of the present invention;

FIG. 1-1 is an electrical diagram, in block and schematic form, of a relevant portion of a receiver that implements a passive polyphase filter (PPF) in conjunction with a mixing DAC;

FIG. 2 is an electrical diagram, in block and schematic form, of a relevant portion of a receiver that includes a mixing DAC and a transimpedance amplifier (TIA), coupled between the mixing DAC and a multi-stage PPF, according to an embodiment of the present invention;

FIG. 3 is an electrical diagram, in block and schematic form, of a relevant portion of a receiver that includes a mixing DAC and a TIA coupled between two PPFs, according to an embodiment of the present invention;

FIG. 4 is an electrical diagram, in block and schematic form, of a relevant portion of a receiver that includes a mixing DAC and two PPFs, with buffers coupled between the PPFs, according to another embodiment of the present invention;

FIG. 5 is an electrical diagram, in block and schematic form, of a relevant portion of a receiver that includes a mixing DAC and three PPFs, with buffers coupled between the PPF, according to an embodiment of the present invention s;

FIG. 6-1 is an electrical schematic diagram depicting a termination technique for a PPF;

FIG. 6-2 is an electrical schematic diagram depicting another termination technique for a PPF;

FIG. 7-1 is an electrical diagram, in block and schematic form, of a relevant portion of a receiver that includes a mixing DAC that implements transconductance boosting in an intermediate frequency (IF) transconductance section, according to an embodiment of the present invention;

FIG. 7-2 is an electrical diagram, in block and schematic form, of a relevant portion of a receiver that includes a mixing DAC that also implements transconductance boosting in an IF transconductance stage, according to another embodiment of the present invention;

FIG. 8 is an electrical diagram, in block and schematic form, of a relevant portion of a receiver that includes a mixing DAC that implements a bootstrapping technique to reduce an effect of internal parasitic capacitance of the mixing DAC, according to another embodiment of the present invention;

FIG. 9 is an electrical diagram, in block and schematic form, of a relevant portion of a receiver that includes a mixing DAC that incorporates another bootstrapping technique to reduce an effect of internal parasitic capacitance of the mixing DAC, according to an embodiment of the present invention;

FIG. 10-1 is an electrical diagram, in block and schematic form, of a relevant portion of a receiver that includes a mixing DAC that implements an active PPF;

FIG. 10-2 is an electrical diagram, in block and schematic form, of a relevant portion of a receiver that includes a mixing DAC that implements both passive and active PPFs; and

FIG. 10-3 is an electrical diagram, in block and schematic form, of a relevant portion of a receiver that implements a mixing DAC in conjunction with a passive PPF and a real-domain bandpass filter, according to another embodiment of the present invention.

The use of the same reference symbols in different drawings indicates similar or identical items.

### DETAILED DESCRIPTION

According to various aspects of the present invention, a radio frequency (RF) receiver is designed to include a mixing digital-to-analog converter (DAC) and one or more polyphase filters (PPFs). As used herein, a “radio frequency” signal means an electrical signal conveying useful information and having a frequency from about 3 kilohertz (kHz) to thousands of gigahertz (GHz), regardless of the medium through which such signal is conveyed. Thus, an RF signal may be transmitted through air, free space, coaxial cable, fiber optic cable, etc. Depending upon the implementation, a front-end PPF may operate in current-mode or voltage-mode. In various configurations, multi-stage PPFs may be implemented to reduce noise, as well as optimize linearity and image rejection ratio (IRR) performance of an associated RF receiver. For example, placing a low-order PPF prior to an active stage may result in a relaxation of matching requirements for the active stage. Using known design techniques, PPFs having 70 to 75 dB of image rejection may be readily designed. Circuit techniques, such as transconductance (gm) boosting and capacitive bootstrapping, may be employed to minimize an impact of parasitic and layout capacitances of a mixing DAC and, thus, increase an IRR of the mixing DAC.

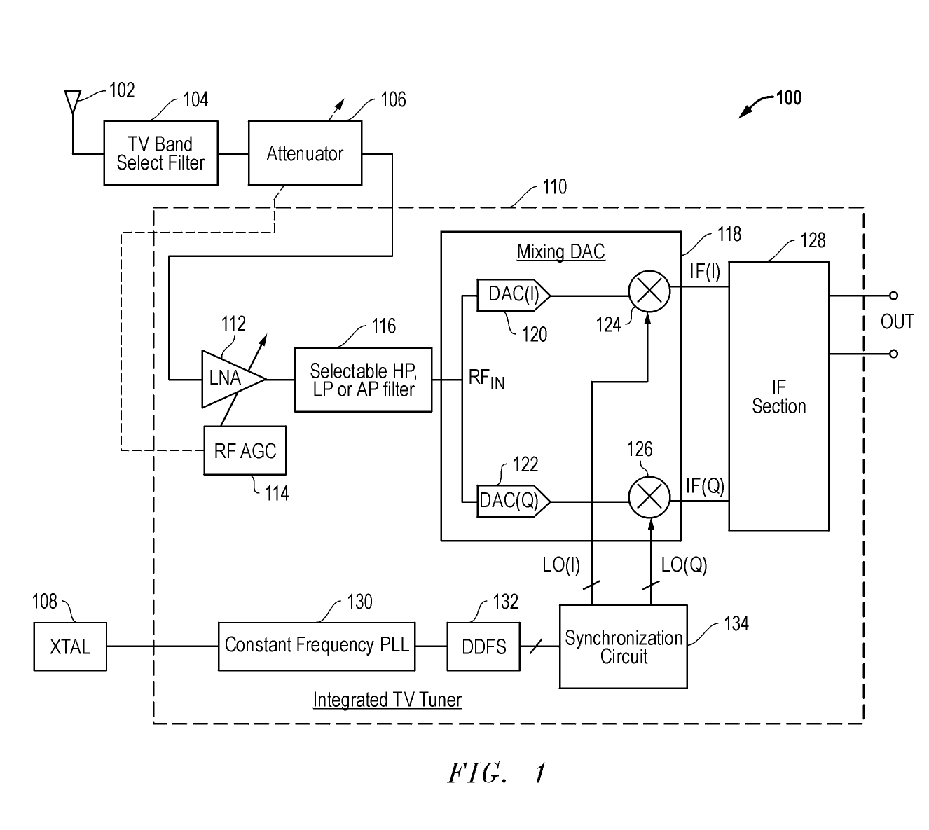

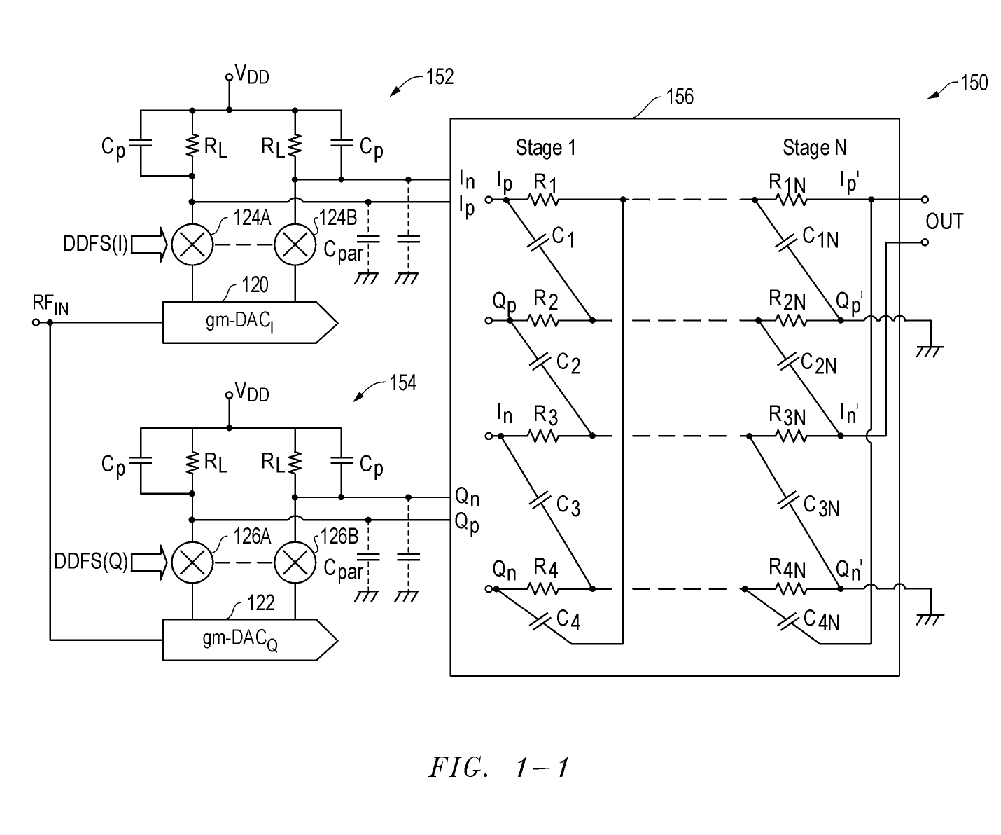

FIG. 1 depicts an exemplary receiver (tuner) 100 that is constructed according to one or more embodiments of the present invention. As is depicted in FIG. 1, the receiver 100 includes an antenna 102 coupled to an input of a TV band select filter 104, whose output is coupled to an input of an attenuator 106. As used herein, the term “coupled” includes both a direct electrical connection between elements and an indirect electrical connection provided by intervening elements. For example, the attenuator 106 is coupled to the antenna 102 indirectly through the TV band select filter 104. An output of the attenuator 106 is coupled to an input of a low noise amplifier (LNA) 112, whose output is coupled to an input of a selectable filter (i.e., a high-pass (HP), low-pass (LP) or all-pass (AP) filter) 116. As is shown, a radio frequency (RF) automatic gain control (AGC) circuit 114 controls the gain of the LNA 112 and the attenuation provided by the attenuator 106. An output of the filter 116 is coupled to an input of mixing DAC 118. The mixing DAC 118 includes a digital-to-analog converter (DAC) 120, whose first input receives the RF input signal (RF_{IN}) and whose output is coupled to an input of mixer (switching section) 124. A second input of the mixer 124 receives a digital in-phase local oscillator (LO(I)) signal from synchronization circuit 134.

The mixing DAC 118 also includes a DAC 122, which receives at a first input the RF input signal, and a mixer (switching section) 126. An output of the DAC 122 is coupled to a first input of the mixer 126. A second input of the mixer 126 receives a digital quadrature LO (LO(Q)) signal from the synchronization circuit 134. In an ideal case, the LO(Q) signal provided to the second input of the mixer 126 is ninety degrees out-of-phase with the LO signal provided to the second input of the mixer 124. An output of the mixer 124 provides an intermediate frequency (IF) in-phase IF(I) signal and an output of the mixer 126 provides an IF quadrature IF(Q) signal. Depending upon the application, the IF(I) and IF(Q) signals may be baseband signals. Outputs of the mixing DAC 118 are coupled to inputs of an IF section 128, which may be configured according to the various embodiments disclosed herein. As is depicted, a crystal 108 provides a reference frequency to a constant frequency phase locked loop (PLL) 130, which provides a constant frequency reference signal to a direct digital frequency synthesizer (DDFS) 132. Outputs of the DDFS 132 are coupled to inputs of the synchronization circuit 134, whose outputs, as previously mentioned, are coupled to the second inputs of the mixer 124 and the mixer 126, respectively.

With reference to FIG. 1-1, a relevant portion of a receiver 150 is depicted that includes a pair of mixing DACs 152 and 154, whose outputs are coupled to an input of a passive polyphase filter (PPF) 156. As is depicted, both negative and positive outputs of the in-phase mixing DAC 152 and the quadrature mixing DAC 154 are provided to associated inputs of the passive PPF 156. Resistors R1-R4 and R1N-R4N and capacitors C1-C4 and C1N-C4N are selected to provide a desired frequency response for the PPF 156. In order to cover multiple communication standards (e.g., U.S., Europe and Japan terrestrial TV) that have different intermediate frequency (IF) values, the PPF 156 may implement a high-order PFF, e.g., a fifth or sixth order PPF. In this case, the nulls of the PPF 156 may be uniformly distributed across an IF range (e.g., from about 30 MHz to 60 MHz).

Uniformly distributing the nulls across an IF range allows a designer to avoid the use of switched PPFs for each TV standard. It should be appreciated that implementing switched PPFs degrades a noise figure and linearity of an IF path of an associated receiver. It should also be appreciated that a fifth-order (or higher-order) passive PPF generally requires relatively large resistors in the last stages of the PPF, if signal attenuation is to be minimized. Unfortunately, implementing relatively large resistors in the last stages of a PPF may result in a relatively large noise figure which degrades sensitivity of the receiver. On the other hand, in integrated circuit (IC) processing, passive devices have a much better matching, as compared to active devices having comparable device size.

In general, I/Q matching of complex mixers that operate at GHz frequencies requires implementation of relatively small devices. Unfortunately, relatively small devices may experience significant mismatches between devices, due to processing limitations. In general, active and passive device mismatches and parasitic capacitive components may dominate the IRR performance of a mixing DAC, as fabricated. To minimize noise contribution of a PPF filter, it is generally desirable to provide a relatively large gain in a mixer of the mixing DAC. Unfortunately, providing a large gain in the mixer requires a relatively large load resistance which, in turn, requires a PPF with a relatively high input impedance to avoid undesirable signal attenuation. Moreover, requiring a PPF to have a relatively high input impedance results in high sensitivity to parasitic capacitance mismatch at outputs of the mixer. Moreover, mixers with high output impedance suffer from poor gain flatness, due to frequency dependent loading of the mixer, which may be attributed to the PPF.

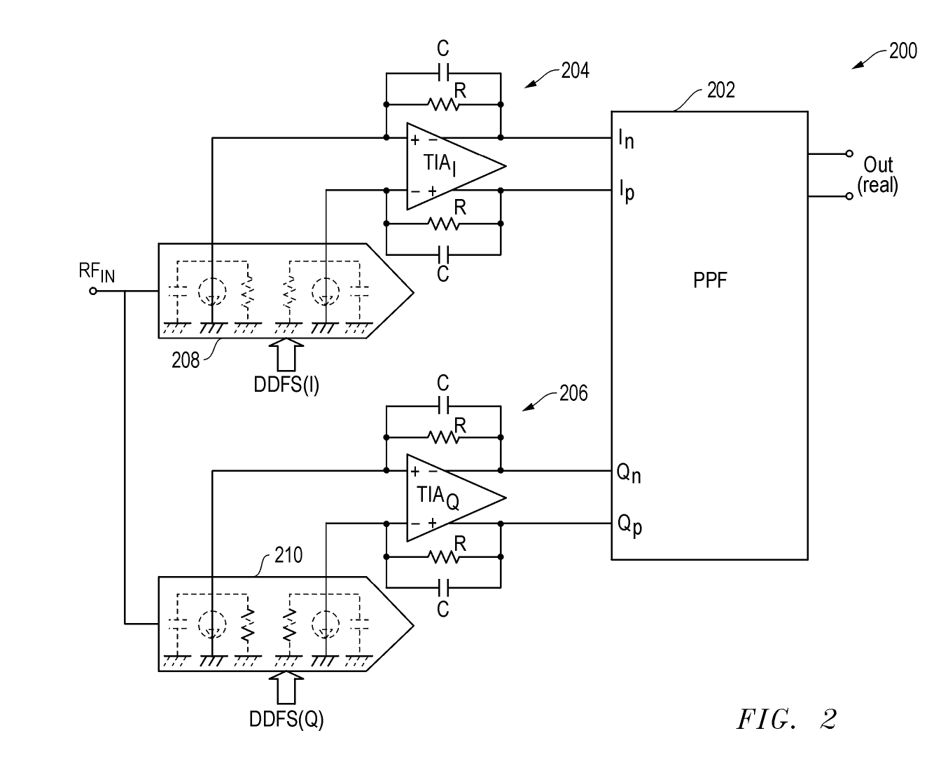

Referring to FIG. 2, a relevant portion of a receiver 200 that is designed to reduce sensitivity to output parasitic capacitance mismatch of a mixing DAC is depicted. As is shown, transimpedance amplifiers (TIAs) 204 and 206 are differentially coupled between outputs of mixing DAC 208 and 210, respectively, and inputs of a polyphase filter (PPF) 202. The output of the mixing DACs 208 and 210 may be essentially modeled as current sources having a parallel output capacitance and a parallel output resistance. The TIAs 204 and 206 perform a current-to-voltage conversion between the outputs of the mixing DACs 208 and 210 and the inputs of the PPF 202.

As the TIAs 204 and 206 provide a small signal ground (not shown in FIG. 2) at their inputs, the voltage across the mixer output capacitance is substantially constant. As such, any parasitic capacitance mismatch at the output of the mixing DACs 208 and 210 is substantially masked. Moreover, the TIAs 204 and 206 provide a constant load at the outputs of the mixing DACs 208 and 210 which provides relatively good mixer gain flatness. It should however be appreciated that placing an active stage in front of the PPF requires relatively stringent matching of amplifier gain bandwidth (GBW) products of the TIAs 204 and 206, which usually results in a relative large power dissipation. Thus, the image rejection of the receiver 200 of FIG. 2 is usually dominated by the GBW product matching between the TIAs 204 and 206. In a multi-stage polyphase filter (PPF), the most stringent matching requirement generally applies to a first stage of the PPF. In each additional PPF stage, the image rejection requirements are typically relaxed.

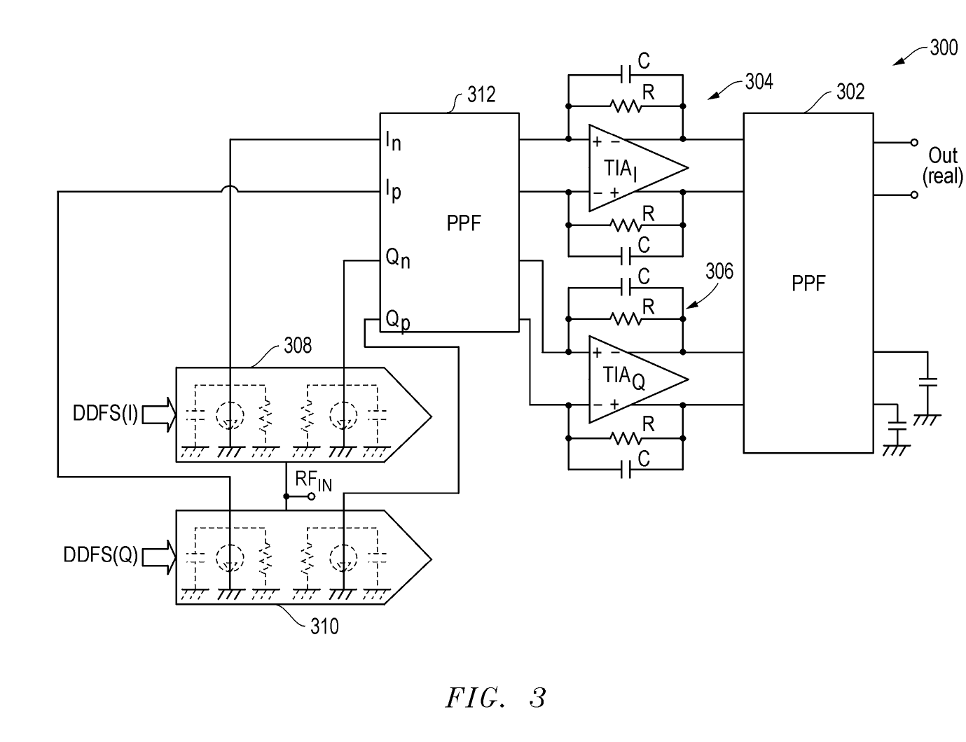

Turning to FIG. 3, a relevant portion of a receiver 300 is depicted that implements a front-end polyphase filter 312 that may include one or more stages. Outputs of mixing DACs 308 and 310 are coupled to inputs of the PPF 312. As is shown, a pair of transconductance amplifiers (TIAs) 304 and 306 are coupled between outputs of the PPF 312 and inputs of PPF 302, which may be, for example, a multi-stage PPF. Implementing a relatively low-order passive PPF in the front-end PPF stage 312 generally relaxes the image rejection requirements on the TIAs 304 and 306. It should be appreciated that PPFs can be operated in a voltage mode or in a current mode. In either case, PPFs present the same image rejection frequency transfer function. The PPF 312 may have a relatively low-order (e.g., a first or second-order). In this case, the output impedance of the mixing DACs 308 and 310 is not zero. As such, capacitors in the first stages of the PPF 312 should be relatively large such that the impedance at the outputs of the mixing DACs 308 and 310 is maintained at a relatively low value. In this case, the mixing DAC output parasitic capacitance mismatch is essentially negligible. As the PPF 312 does not implement a bandpass feature, the entire frequency spectrum from the outputs of the mixing DACs 308 and 310 is provided to the inputs of the TIAs 304 and 306. As such, the TIAs 304 and 306 should be selected to provide relatively good linearity, which may require implementation of higher power TIAs. In general, a voltage mode mixer output is preferable, from both power dissipation and linearity standpoints.

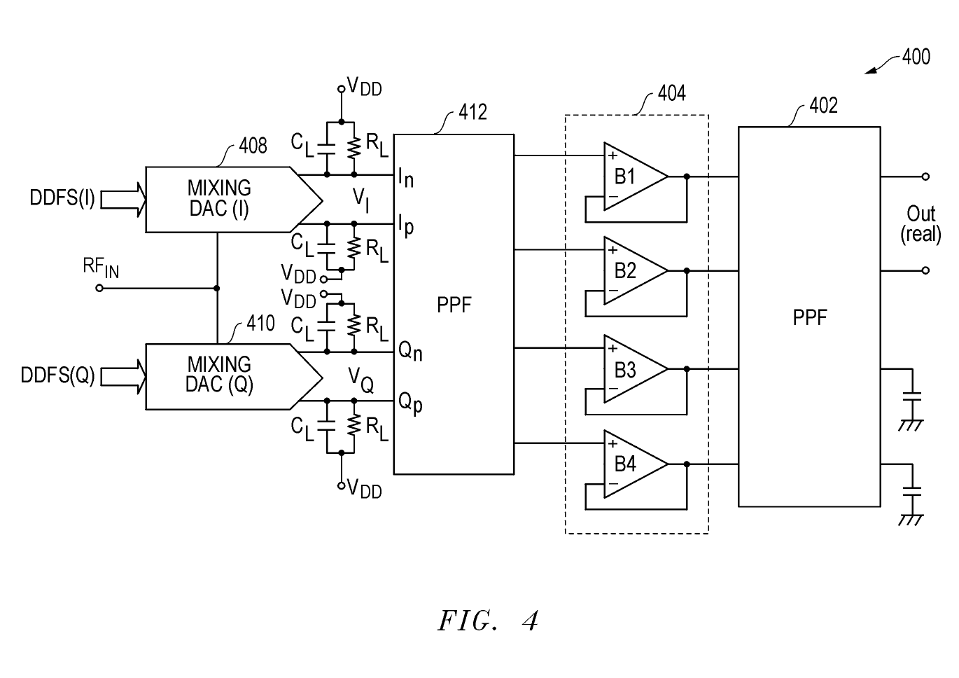

With reference to FIG. 4, a relevant portion of a receiver 400 is depicted that includes a pair of PPFs 412 and 402 and an active buffer stage 404. As is shown, outputs of mixing DACs 408 and 410 are provided to inputs of the PPF 412, which in this case is a voltage mode PPF. A voltage is created across load resistors R_{L}, which are coupled between outputs of the mixing DACs 408 and 410 and VDD. Outputs of the PPF 412 are coupled to respective inputs of buffers B1-B4, whose outputs are provided to inputs of the PPF 402. The PPF 412 provides an image rejection relaxation for the stages that follow, e.g., 6 to 12 dBs, without requiring large resistor values that may degrade a noise figure performance of the receiver. As the PPF 412 relaxes the image rejection requirements, the buffer stage 404 may be advantageously implemented between the PPF 412 and 402. The buffers B1-B4 may be, for example, unity gain amplifiers or may provide some gain, e.g., a 6 dB gain, which in general may further reduce any noise impact at the back-end PPF 402.

In general, to relax the linearity requirements of the buffers B1-B4, a real pole (set by values of output load resistance R_{L} and load capacitance C_{L}) at the outputs of the mixing DACs 408 and 410 should generally be set as low as possible within a targeted gain drop specification. Placing buffers B1-B4 between the outputs of the PPF 412 and the inputs of the PPF 402 in effect resets the increasing resistor pattern which further reduces the noise contributed by the last stage(s) of the PPF 402. It should be appreciated that achieving high matching of buffers that also provide gain may result in compromises. In high-order PPFs (e.g., fifth-order or higher), the front-end PPF may have an order of two and a back-end PPF may have an order of N−2. In any case, the back-end PPF generally has a relatively large number of cascaded stages that generally require relatively large resistor values for the last stages. Thus, the relatively large resistors in a last stage of the back-end PPF generally dominate the IF path noise figure.

It should be appreciated that in some applications it may be desirable to use a higher number of split PPFs and inter-PPF active buffers. Depending upon the application, better performance may be achieved by using a front-end PPF, an intermediate PPF and a back-end PPF with inter-PPF buffers. For example, when linearity and IRR are more important, a fifth-order PPF (with inter-PPF buffers) can be split into a front-end PPF having two stages, an intermediate PPF having two stages and a back-end PPF having one stage. As another example, when noise figure is more important, a fifth-order PPF (with inter-PPF buffers) can be split into a front-end PPF with a single stage, an intermediate PPF with two stages and a back-end PPF with two stages.

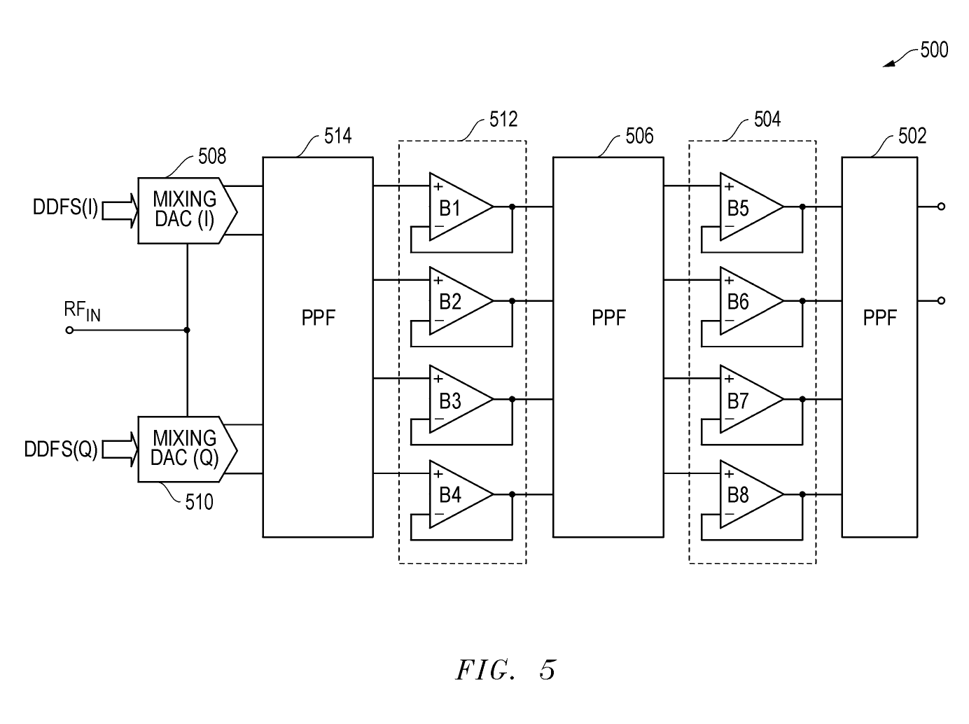

Referring to FIG. 5, a relevant portion of a receiver 500 that includes a front-end PPF 514, an intermediate PPF 506 and a back-end PPF 502 is illustrated. As is shown, outputs of mixing DACs 508 and 510 are provided to respective inputs of the PPF 514. Outputs of the PPF 514 are coupled to respective inputs of buffer stage 512, which includes buffers B1-B4. Outputs of the buffer stage 512 are coupled to respective inputs of an intermediate PPF 506, whose outputs are coupled to respective inputs of buffer stage 504, which includes buffers B5-B8. Outputs of the buffer stage 504 are coupled to respective inputs of the back-end PPF 502.

It should be appreciated that different configurations can be used for the inter-stage buffers. For example, the buffers in the buffer stages 512 and 504 may have different gains. As another example, the buffers B1-B4 of the buffer stage 512 may have a unity gain for best linearity, while the buffers B5-B8 in the buffer stage 504 may have a gain of two in order to effectively attenuate noise in later stages of the back-end PPF 502. It should be understood that implementing buffer stages, while reducing a noise figure performance, increases the power requirements of the receiver. It should also be appreciated that the same multi-PPF technique may be applied to receivers having a current-mode front-end PPF, which receives input from a mixing DAC via a transimpedance amplifier. In the case where a front-end PPF operates in current-mode, following PPFs operate in voltage-mode. In a multi-stage PPF, the designer should consider the order in which the poles are realized. For example, progressing from a highest frequency pole at a front-end PPF to a lowest frequency pole at a back-end PPF may result in optimum resistor ratios between adjacent stages. However, minimizing loading on outputs of a mixing DAC may require a lowest frequency pole to occur at a front-end PPF. Thus, depending upon the application, a designer should carefully consider the placement of the poles of the PPFs.

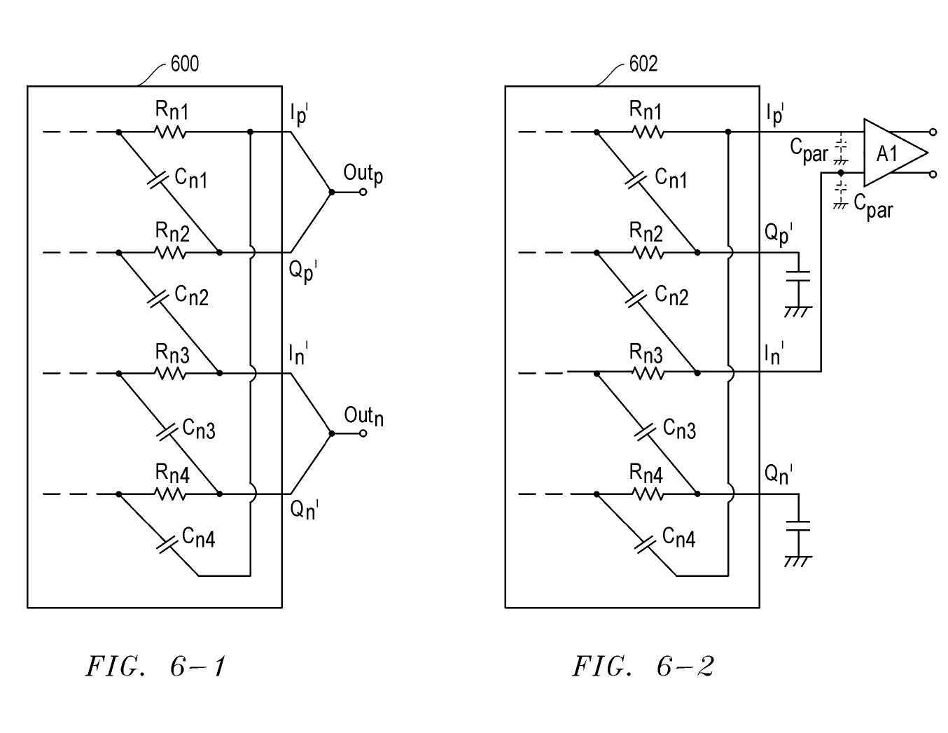

An output of a PPF may be configured in a number of ways. With reference to FIG. 6-1, a relevant portion of a PPF 600 is depicted in which the Iₚ and Qₚ outputs are shorted and the Iₙ and Qₙ outputs are shorted. This configuration provides load balance and generally provides optimum image rejection performance. However adding I and Q essentially causes a 3 dB signal loss, which increases noise contribution at the IF stages following the PPFs. Turning to FIG. 6-2, a relevant portion of a PPF 602 is shown in which quadrature (Q) outputs, Qₚ′ and Qₙ′ are coupled to ground, via capacitors C, and in-phase outputs, Iₚ′ and Iₙ′ are provided to differential inputs of a differential amplifier A1. It should be appreciated that the outputs that are grounded may be switched, i.e., the output may be taken from the Q outputs instead of the I outputs. Terminating one set of outputs to ground with matched termination capacitors provides a 3 dB higher gain than can be achieved by shorting outputs, as is discussed in conjunction with FIG. 6-1. As noted above, increasing the gain provides better noise performance for the receiver. However, the mismatch between the termination capacitors and the input capacitance of the following IF stage(s) may cause degradation in image rejection performance. Assuming a matched capacitive termination is used, the single termination solution may be preferable due to its better noise performance.

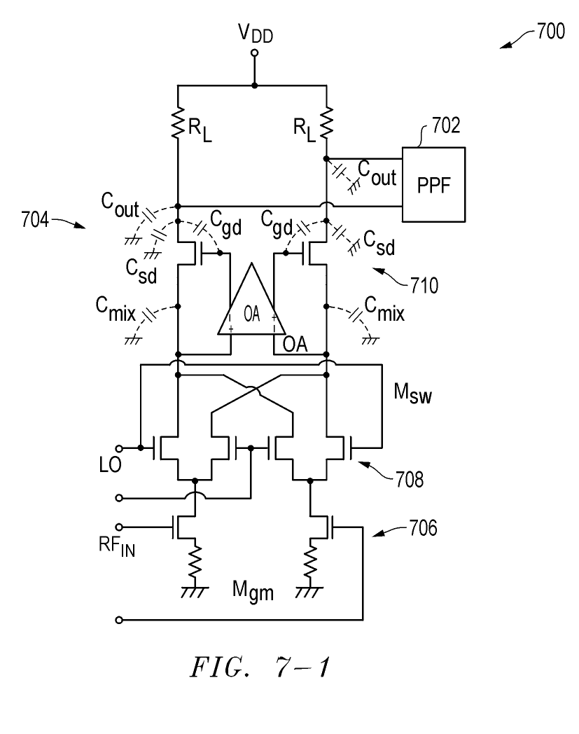

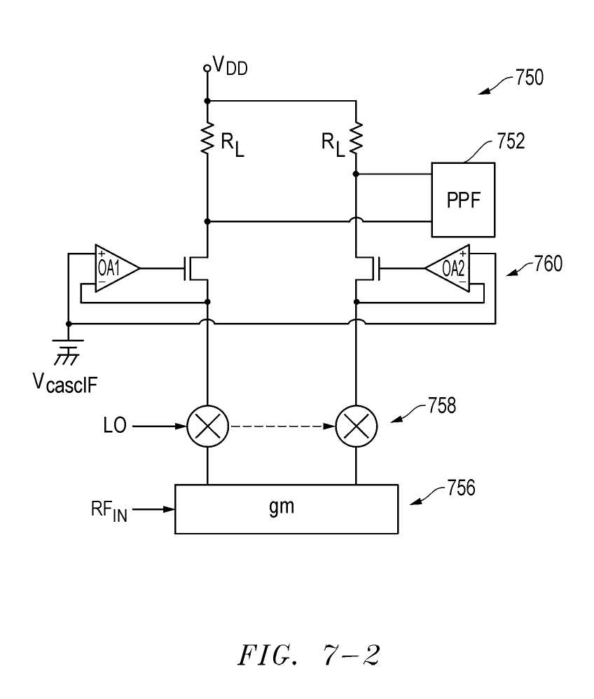

With reference to FIG. 7-1, a relevant portion of a receiver 700 is depicted that implements relatively small sized cascode intermediate frequency (IF) transistors in an IF cascode transconductance section 710 to minimize an output capacitance of mixing DAC 704, while still allowing for the implementation of relatively large area switching transistors for switching section (M_{sw}) 708. As is shown, an RF transconductance section (M_{gm}) 706 receives an RF input signal, i.e., an RF voltage signal, which is converted to an RF current signal. The RF current signal is provided to the switching section 708, which also receives digital bits corresponding to a local oscillator (LO) signal and mixes the bits with the RF current signal to provide an IF analog current signal at the outputs of the switching section 708.

In the embodiment depicted in FIG. 7-1, the LO signal only includes a single bit (and its compliment). It should be appreciated that the bit size of the mixing DAC dictates the number of transistors that are implemented in the switching section 708 of mixing DAC 704. For example, assuming a 10-bit binary encoded DAC, ten differential switching sections comparable to the ones shown in FIG. 7-1 (but having different resistive values in each leg) are implemented. As another example, assuming a fully thermometer encoded DAC having ten bits, the number of switching sections required would correspond to 2¹⁰−1. As another example a mixing DAC incorporating five thermometer encoded bits and five binary encoded bits would require thirty-six differential switching pairs (i.e., ((2⁵−1)+5)).

In a typical implementation, transistors of the cascode transconductance section 710 are selected to have a relatively small size. In general, small size transistors have a relatively low transconductance value. As such, the transistors of the cascode transconductance section 710, without boosting, have a low transconductance value and, therefore, provide a high impedance to an output of the switching section 708. Unfortunately, this may cause a translation of the critical matching point from the mixing DAC 704 output to the output of the switching section 708. To avoid this effect, it is desirable to increase the transconductance value of the transistors of the cascode transconductance section 710. To achieve a relatively large value for a small size device, transconductance (gm) boosting may be implemented by incorporating an operational amplifier (OA) having differential inputs and differential outputs. Inputs of operational amplifier OA are coupled to outputs of the switching section 708 and outputs of the operational amplifier OA are coupled to gates of the transistors of the cascode transconductance section 710.

As an alternative to a implementing a fully differential-in, differential-out operational amplifier, a pseudo-differential architecture, as is incorporated in receiver 750 of FIG. 7-2 may be implemented. The pseudo-differential amplifier may be implemented by configuring operational amplifiers OA1 and OA2 in a single-ended implementation. It should be appreciated that the embodiment shown in FIG. 7-1 provides a higher GBW product for a given power budget. In either case, an equivalent transconductance at the output of a mixing DAC is boosted, which causes a pole frequency at an output of a switching section to occur at a higher frequency, avoiding the parasitic capacitance mismatch impact.

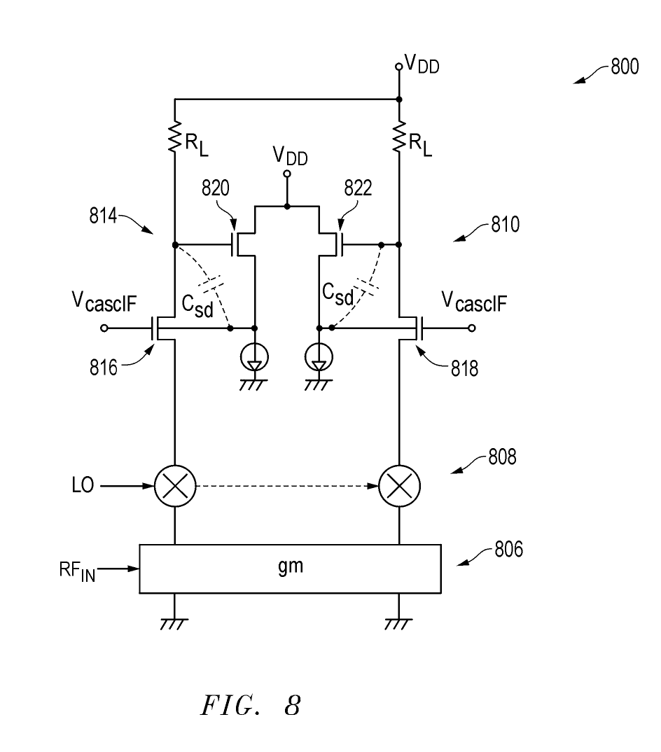

In general, an output parasitic capacitance Cₒᵤₜ of an IF cascode transconductance section is dominated by a drain-to-substrate capacitance. In this case, a better matching of a mixing DAC output can be achieved by using a bootstrap technique to address the drain-to-substrate capacitance. With reference to FIG. 8, a relevant portion of a receiver 800 is depicted that implements a bootstrap technique for addressing drain-to-substrate capacitance of an IF cascode transconductance section 810 of a mixing DAC 814. In the illustrated implementation, two relatively low size followers 820 and 822 are utilized to maintain a potential on drain-to-substrate capacitances of transistors 816 and 818, respectively, of the cascode transconductance section 810 at substantially equal values to eliminate the mismatch effect. It should be appreciated that the followers 820 and 822 add parasitic capacitance, due to their input capacitance. However, the input (i.e. gate) capacitance has a much better matching in comparison with the substrate capacitance, which is typically poorly controlled by current commercial processes. As previously noted, in a mixing DAC architecture the overall image rejection performance is determined by matching the internal nodes of the mixing DAC. As mentioned, mismatched terms are generally provided by transistor transconductance (gm) mismatches and parasitic capacitance (Cₚₐᵣ) mismatches. In the usual case, the transconductance mismatch is a low frequency mismatch, which is well defined by device size.

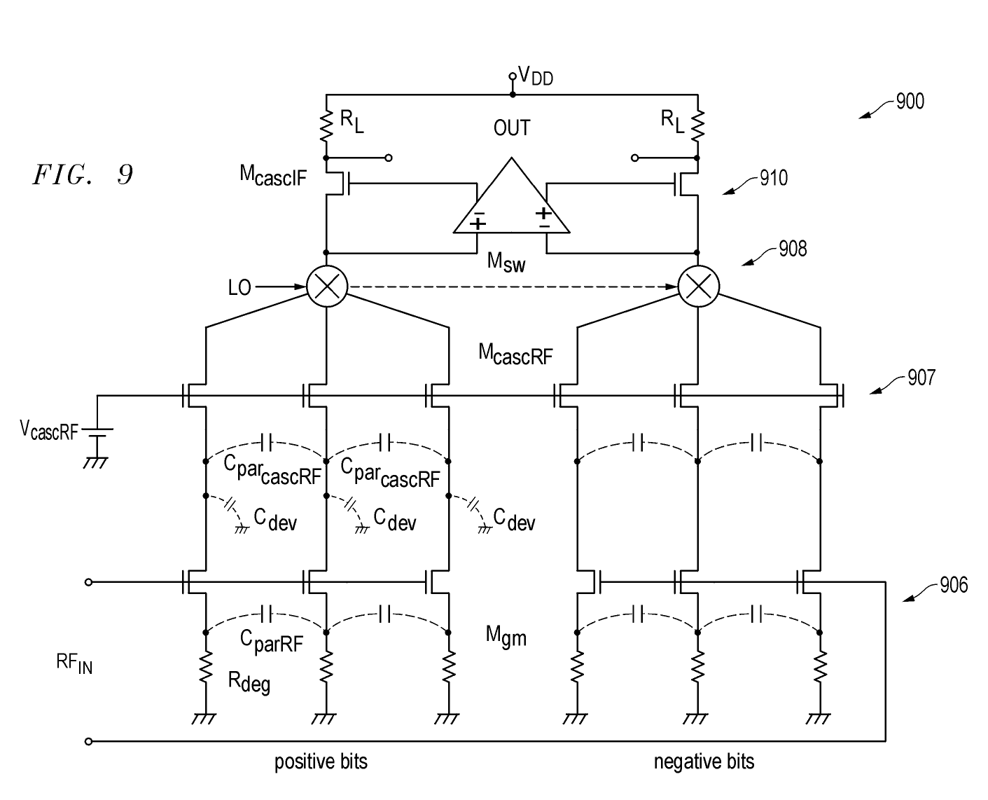

Turning to FIG. 9, a mixing DAC 900 is illustrated with a number of associated parasitic capacitances at various stages. The mixing DAC 900 implements a split transconductance DAC that incorporates resistive degeneration in an RF transconductance section (M_{gm}) 906. Resistors (R_{deg}) provide resistive degeneration, which generally improves matching of the transistors of the RF transconductance section 906. The RF cascode transconductance section (M_{cascRF}) 907 functions to reduce a parasitic capacitance seen by a switching section (M_{sw}) 908 and an IF cascode transconductance section (M_{caseIF}) 910 functions to minimize a parasitic capacitance at an output of switching section (mixer) 908.

In a typical IC, to minimize IC size, different bit circuits are packed relatively close together. Unfortunately, packing the different bit circuits in close proximity results in relatively large parasitic capacitance (C_{parRF}) and (C_{parCASCRF}) between the different bit lines. According to one aspect of the present invention, the positive bits are routed together and the negative bits are routed together in order that the parasitic capacitors C_{parRF} and C_{parCASCRF} see the same potential on both sides and, therefore, are essential invisible up to frequencies of interest. Implementing this technique reduces the impact of parasitic capacitance on the mixing DAC signal path nodes by essentially neutralizing the layout parasitic capacitance which leaves the device parasitic capacitance (C_{dev}) to set the effective pole position. The neutralizing effect is generally effective up to frequencies comparable to the gm of M_{cascRF}/C_{dev}.

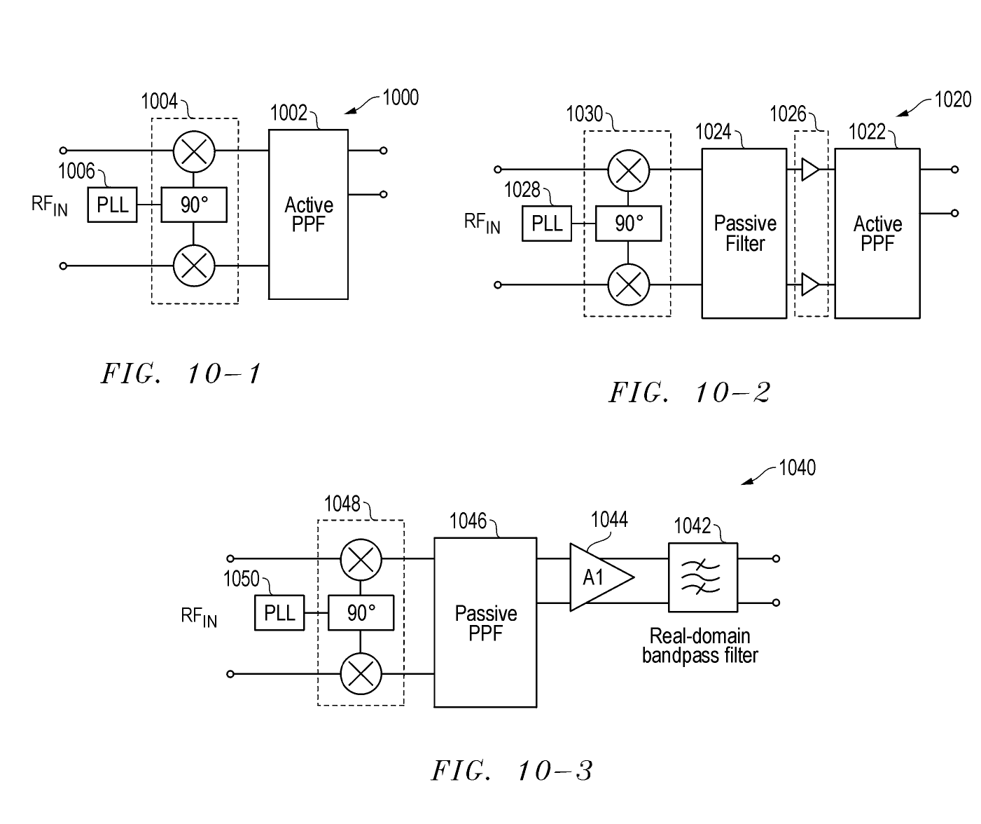

Depending upon the application, it may be desirable for a PPF to exhibit a bandpass characteristic that rejects most out-of-band intermodulation products (in order to relax linearity requirements of IF stages following the PPF). Unfortunately, passive PPFs do not generally exhibit a bandpass characteristic. With reference to FIG. 10-1, a relevant portion of a receiver 1000 is depicted that implements a bandpass characteristic that rejects most out-of-band intermodulation products provided at an output of a mixing DAC 1004. In this embodiment, an active PPF 1002 is implemented to provide the bandpass characteristic. It should be appreciated that an active PPF may cause an associated receiver to exhibit increased noise and higher power dissipation. Furthermore, to provide satisfactory performance, active amplifiers of a PPF are generally required to meet relatively stringent amplifier gain (AV) and gain bandwidth (GBW) product matching constraints.

Moving to FIG. 10-2, a receiver 1020 is depicted that implements a passive front-end PPF 1024, in conjunction with an active back-end PPF 1022. As is depicted, outputs of mixing DAC 1030 are coupled to associated inputs of the PPF 1024 and a buffer stage 1026 is coupled between outputs of the PPF 1024 and inputs of the back-end PPF 1022. In general, the passive front-end PPF 1024 relaxes the matching requirements for the active back-end PPF 1022. Unfortunately, the noise at the active back-end PPF 1022 is still greater than that of a passive PPF. Implementation of the inter-stage buffer 1026 generally improves the noise figure of the hybrid (passive/active) PPF implementation.

Turning to FIG. 10-3, a relevant portion of a receiver 1040 is depicted that includes a passive PPF 1046, whose inputs are coupled to outputs of a mixing DAC 1048 Outputs of the PPF 1046 are coupled to inputs of a differential amplifier 1044, whose outputs are coupled to inputs of a real-domain bandpass filter 1042. In this embodiment, the bandpass characteristic is provided by the real-domain bandpass filter 1042, which is placed in the signal path following the complex-to-real conversion by the passive PPF 1046. While the embodiment provides good noise and linearity performance, the embodiment also places relatively stringent linearity constraints on the amplifier 1044, as the amplifier 1044 sees a wide frequency bandwidth with relatively large intermodulation products. Placing a passive bandpass filter at the output of the first gain stage (A1) helps reduce linearity constraints on following IF path stages which reduces power dissipation in the IF path.

Accordingly, a number of radio frequency receiver architectures have been disclosed herein that implement mixing digital-to-analog converters in conjunction with one or more polyphase filters to improve an image rejection performance of a receiver.

The above-disclosed subject matter is to be considered illustrative, and not restrictive, and the appended claims are intended to cover all such modifications, enhancements, and other embodiments that fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A receiver, comprising:
a mixing digital-to-analog converter (DAC), comprising:
a radio frequency (RF) transconductance section having an input for receiving an RF signal and an output for providing an RF current signal; and
a switching section coupled to the RF transconductance section, the switching section having inputs for receiving bits associated with a digital local oscillator (LO) signal and having outputs, wherein the switching section is configured to mix the RF current signal with the digital LO signal to provide an analog output signal at the outputs of the switching section;
a direct digital frequency synthesizer (DDFS) having outputs configured for providing the bits associated with the digital LO signal to the inputs of the switching section;
a transimpedance amplifier (TIA) having inputs each coupled to a respective one of the outputs of the switching section and outputs; and
a first polyphase filter (PPF) having inputs each coupled to a respective one the outputs of the TIA.

2. The receiver of claim 1, wherein the first PPF is a multi-stage passive PPF.

3. The receiver of claim 1, wherein positive bit lines of the mixing DAC are routed together and negative bit lines of the mixing DAC are routed together.

4. The receiver of claim 1, wherein output pairs of the first PPF are shorted.

5. The receiver of claim 1, further comprising:
a second PPF coupled between the outputs of the switching section and the inputs of the TIA.

6. The receiver of claim 5, wherein the second PPF is a single-stage passive PPF and the first PPF is a multi-stage passive PPF.

7. The receiver of claim 5, wherein the mixing DAC further comprises:
a transconductance boosting section coupled between the outputs of the switching section and the inputs of the second PPF.

8. The receiver of claim 7, wherein the mixing DAC further comprises:
a substrate capacitance bootstrapping circuit coupled to outputs of the transconductance boosting section.

9. A receiver, comprising:
a mixing digital-to-analog converter (DAC), including:
a radio frequency (RF) transconductance section having an input for receiving an RF signal and an output for providing an RF current signal;
a switching section coupled to the RF transconductance section, the switching section having inputs for receiving bits associated with a digital local oscillator (LO) signal and having outputs, wherein the switching section is configured to mix the RF current signal with the digital LO signal to provide an analog output signal at the outputs of the switching section; and
a pair of resistive loads each coupled to respective ones of the outputs of the switching section;
a direct digital frequency synthesizer (DDFS) having outputs configured for providing the bits associated with the digital LO signal to the inputs of the switching section;
a first polyphase filter (PPF) having inputs each coupled to respective ones of the outputs of the switching section;
a second PPF including a plurality of inputs and a plurality of outputs; and
a plurality of buffers each coupling a respective one of the outputs of the first PPF to an associated respective one of the inputs of the second PPF.

10. The receiver of claim 9, wherein the first PPF is a single-stage passive PPF and the second PPF is a multi-stage passive PPF.

11. The receiver of claim 9, wherein the first PPF is a multi-stage passive PPF and the second PPF is a multi-stage passive PPF.

12. The receiver of claim 9, wherein the plurality of buffers are unity gain operational amplifiers.

13. The receiver of claim 9, further comprising:
a third PPF including a plurality of inputs; and
a plurality of second buffers each coupling a respective one of the outputs of the second PPF to an associated respective one of the inputs of the third PPF.

14. The receiver of claim 9, wherein positive bit lines of the mixing DAC are routed together and negative bit lines of the mixing DAC are routed together.

15. The receiver of claim 9, wherein the second PPF is an active PPF.

16. The receiver of claim 9, wherein the mixing DAC further comprises:
a transconductance boosting section coupled between the outputs of the switching section and the inputs of the first PPF.

17. The receiver of claim 16, wherein the mixing DAC further comprises:
a substrate capacitance bootstrapping circuit coupled to outputs of the transconductance boosting section.

18. A receiver, comprising:
a mixing digital-to-analog converter (DAC), including:
a radio frequency (RF) transconductance section having an input for receiving an RF signal and an output for providing an RF current signal;
a switching section coupled to the RF transconductance section, the switching section having inputs for receiving bits associated with a digital local oscillator (LO) signal and having outputs, wherein the switching section is configured to mix the RE current signal with the digital LO signal to provide an analog output signal at the outputs of the switching section; and
a pair of resistive loads each coupled to respective ones of the outputs of the switching section;
a direct digital frequency synthesizer (DDFS) having outputs configured for providing the bits associated with the digital LO signal to the inputs of the switching section;
a passive polyphase filter (PPF) having inputs each coupled to respective ones of the outputs of the switching section;
a differential amplifier with inputs each coupled to respective outputs of the passive PPF; and
a bandpass filter with inputs each coupled to respective outputs of the differential amplifier.

19. The receiver of claim 18, wherein the passive PPF includes a plurality of cascaded stages.

20. The receiver of claim 19, further comprising:
at least one buffer stage coupling outputs of one of the plurality of cascaded stages to inputs of an adjacent one of the plurality of cascaded stages.
